(19) United States
(12) Patent Application Publication
(10) Pub. No.: US 2019/0000056 A1
(43) Pub. Date: Jan. 3, 2019

(54) Firefly - Fish Bite Notification Electronic System

(71) Applicant: Kyle Sheldon Boney, (US)

(72) Inventor: Kyle Sheldon Boney, Gautier, MS (US)

(21) Appl. No.: 15/640,519

(22) Filed: Jul. 1, 2017

(51) Int. Cl. A01K 89/015; A01K 97/12; A01K 89/01

(52) U.S. Cl. CPC A01K 89/0179; A01K 89/0123; A01K 97/125

(57) ABSTRACT

The present invention comprises a fish strike indicator system that completes a circuit, based on the clicker mechanism. This notification shall include light(s) and/or wireless notification to an external device.

### FIELD OF THE INVENTION

The present invention relates to fishing reel and rod devices and apparatuses for notification of fish strike. More particularly, the invention relates to a notification device that is directly operated from the drag mechanism and clicker and the like.

### BACKGROUND

Fishing strike indicators are an important part of the overall fishing experience, in relation to catching the fish in a timely manner. The core of this is the drag and clicker mechanism that currently is solely comprised of mechanical apparatus, and is dependent of the hearing ability of the fisherman.

Fish strike indicators that are hearing only notifications will work under ideal conditions, where wind and other noises are not a concern. However wind, noise from outside factors, as well as other reels and their clicker mechanisms would impede the core functionality.

Certain circumstances that would require the fisherman to divert his attention from the reel, such as a conversation with others, phone call, or a short trip away from the rod and reel, would also impede the functionality of a mechanical clicker based notification system.

Hearing impaired fishermen would not receive benefit from a mechanical clicker sound as well, as their hands would have to be placed on the reel itself to receive feedback.

Therefore, a need exists in the field for fish strike indicator that would go beyond mechanical sound based clicker mechanism. The mechanism has served well for many years, but better notification can come with the use of technology.

### BRIEF SUMMARY OF THE INVENTION

The present invention comprises an electronic circuit, that would be completed if the mechanical clicker was engaged. This electronic circuit would then be capable of multiple tasks, such as lighting a notification LED for visual notification, as well as wireless notification to a cell phone or handheld device for vibration sensory and/or visual notification.

### BRIEF DESCRIPTION OF THE DRAWINGS

Some embodiments of the present invention are illustrated as an example and are not limited by the figures of the accompanying drawings, in which like references may indicate similar elements and in which:

FIG. 1-FIG. 1 depicts an exploded perspective view of one example of a “Baitcast” type reel, with the electronic circuitry in place for LED notification.

FIG. 2-FIG. 2 depicts an exploded perspective view of one example of a “Spinning (fixed-spool)” type reel, with the electronic circuitry in place for LED notification.

FIG. 3-FIG. 3 shows a view of an example assembly of an LED notification as placed inside of a “Baitcast” type reel.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a”, “an” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of mechanical and electrical components, as well as processes are disclosed. Each of these has individual benefit and each can also be used in conjunction with one or more, or in some cases all, of the other disclosed mechanical and electrical components and processes. Accordingly, for the sake of clarity, this description will refrain from repeating every possible combination of the individual components in an unnecessary fashion. Nevertheless, the specification and claims should be read with the understanding that such combinations are entirely within the scope of the invention and the claims.

New electronic and mechanical methods of fishing strike notification are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

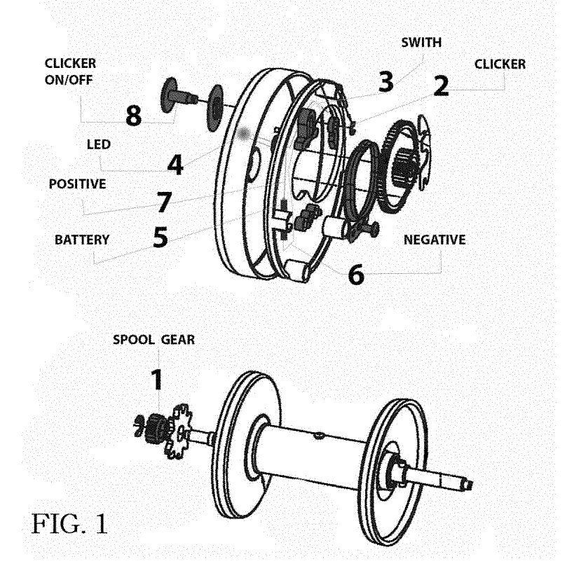

The present invention will now be described by referencing the appended figures representing preferred embodiments. FIG. 1 depicts an exploded perspective view of the elements that may comprise a “Baitcast” type reel, with the electronic circuitry in place for LED notification.

FIG. 1 shows the detailed circuit and mechanism for the “Baitcast” type reel, starting with the (1) spool gear that moves the (2) clicker mechanism. In the highest position of the clicker mechanism, the (3) switch is engaged. This completes the circuit allowing electricity to flow through the (4) LED light and/or Bluetooth device. The circuit is powered by a (5) battery and connected with stainless steel wires (6) Negative and (7) Positive.

When (8) clicker switch is disengaged, the circuit cannot be engaged.

In a situation where constant or interrupted tension is applied to the (1) spool gear, and the (8) clicker switch is engaged, the circuit will complete.

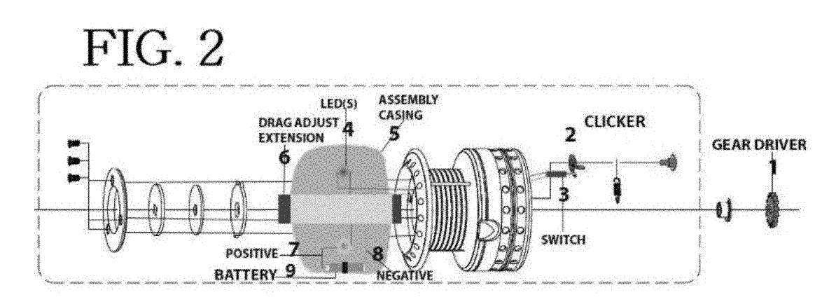

As shown in FIG. 2, the assembly is oriented to suit a “Spinning (fixed-spool)” type reel, with the electronic circuitry in place for LED notification. This orientation allows for the assembly to spin with the spool, while the electronic circuit is still engaged with the clicker mechanism. When the spool moves, the (2) clicker mechanism is activated against the (1) stationary gear driver, causing the (2) clicker mechanism to engage the (3) switch, completing the circuit. The (4) LED(s) and (9) battery, (8) negative and (7) positive wiring is the same as the “Bate Caster” circuitry. The electronic components are mounted in the (5) assembly casing. The circuitry is dependent on the adjustment made to the (6) drag adjustment.

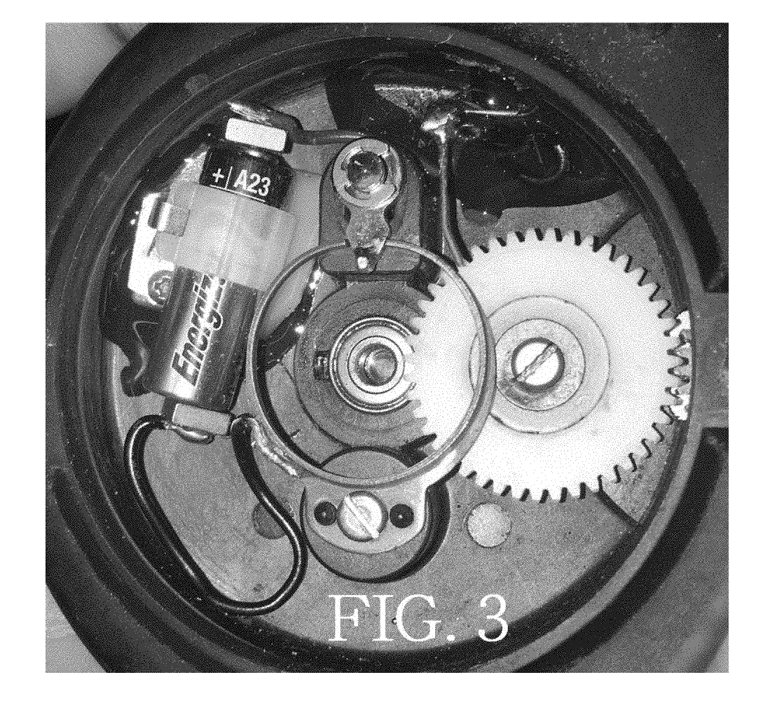

FIG. 3 shows a view of a Prototype LED notification as placed inside of a “Baitcast” type reel in a typical assembly. Similar to (FIG. 1), the basic diagram relies on the clicker mechanism to complete a circuit.

While preferred materials, components and/or electronic circuitry/chips for elements have been described, the device is not limited to these, and may be substituted by other materials, components and electronic circuitry/chips performing similar functionality.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A fish strike indicator comprising:
a. an electronic circuit;
b. a battery; and
c. a notification component(s) that include light(s).

2. The fish strike notification device of claim 1 further comprising an wireless notification.
